(19) United States
(12) Patent Application Publication
(10) Pub. No.: US 2020/0307060 A1
(43) Pub. Date: Oct. 1, 2020

(54) APPARATUS FOR RECYCLING WASTE AUTOMOBILE FLOOR MAT

(71) Applicant: NSTEC CO., LTD., Asan-si (KR)

(72) Inventors: Seoung Gue BAIK, Asan-si (KR); Dae Hyung KIM, Chungcheongnam-do (KR)

(21) Appl. No.: 16/496,474

(22) PCT Filed: Nov. 21, 2017
(86) PCT No.: PCT/KR2017/013216

§ 371 Date: Sep. 23, 2019

(30) Foreign Application Priority Data
Oct. 19, 2017 (KR) 10-2017-0135638

(51) Int. Cl. B29C 48/285; B29B 17/04; B29C 48/00

(52) U.S. Cl. CPC B29C 48/287; B29K 2023/12; B29C 48/022; B29B 17/04

(57) ABSTRACT

An apparatus for recycling a waste automobile floor mat according to the present invention includes: a plurality of conveyer belts which is sequentially disposed and transfers compressed, cut, crushed scraps; a first cutter which cuts each of the compressed, transferred scraps at predetermined intervals; a crusher which crushes the cut, transferred scraps; a pair of first hoppers into and from which the crushed, transferred scraps and polypropylene are introduced and discharged, respectively; a pair of first screw conveyers which transfer the scraps and the polypropylene; a second hopper into and from which the scraps and the polypropylenes are introduced and discharged; a second screw conveyer which transfers the scraps and the polypropylene; a melter which melts the scraps and the polypropylene; a third screw conveyer which forms an extrudate by extruding the mixed, molten scraps and polypropylene; and a second cutter which cuts the extrudate at predetermined intervals.

### TECHNICAL FIELD

The present invention relates to an apparatus for recycling a waste automobile floor mat by means of a single process, and more specifically to an apparatus for recycling a waste automobile floor mat by means of a single process, which produces a primary melt by crushing and then melting a waste automobile floor mat, produces a secondary melt by adding polypropylene to the primary melt to form a mixture and then agitating and melting the mixture, and produces a plastic recycled product by extruding the second melt.

### BACKGROUND ART

In recent years, as interest in the protection of the environment has increased, various measures for the protection of the environment have been proposed and carried out voluntarily or forcibly through regulations. Technology for treating various types of wastes generated by automobiles is also one of such measures.

Accordingly, in the automobile industry, a lot of effort is being made to reduce the wastes generated in the manufacture of automobiles in addition to the wastes generated from waste vehicles. In particular, since waste metals, which are non-metallic wastes, are difficult to recycle and have a bad effect on an environment for a long time in the case of landfill, they are mostly incinerated, but toxic gases generated during incineration cause another problem of causing air contamination.

As inventions regarding the recycling of a waste automobile floor mat in order to solve the above problems, there were proposed and disclosed Korean Patent Application Publication No. 1997-0014969 entitled “Method for Manufacturing Recycled Board Using Waste Carpets and Carpet Scraps,” Korean Patent Application Publication No. 1999-018283 entitled “Method for Manufacturing Recycled Resin Using Waste Nylon Carpet of Automobile,” Korean Patent Application Publication No. 2002-0087197 entitled “Method for Manufacturing High-Performance Recycled Board Using Waste Parts,” and Korean Patent No. 10-0714990 entitled “Apparatus for Recycling Construction Wastes and Automobile Waste Carpet.”

Korean Patent Application Publication No. 1997-0014969 entitled “Method for Manufacturing Recycled Board Using Waste Carpets and Carpet Scraps” discloses an invention regarding a method for manufacturing a recycled board, in which a waste carpet or carpet scraps are crushed to a size of 8 to 10 mm and extruded at a temperature of 205 to 265° C. to prepare a primary extrudate, the extrudate is crushed to a size of 5 to 8 mm, polypropylene or polyethylene and wood flour are added and mixed with the extrudate to form a mixture, the mixture is secondarily extruded and molded at a temperature of 180 to 240° C., thereby manufacturing a recycled board used as a material for automobile parts. Korean Patent Application Publication No. 1999-018283 entitled “Method for Manufacturing Recycled Resin Using Waste Nylon Carpet of Automobile” discloses an invention regarding a method for manufacturing recycled resin, in which a waste nylon carpet for automobile is recovered, crushed, extruded and re-crushed and mixed with thermoplastic resin and a modifier in an appropriate ratio to form a mixture, and the mixture is melted, extruded and molded, thereby manufacturing recycled resin.

Furthermore, Korean Patent Application Publication No. 2002-0087197 entitled “Method for Manufacturing High-Performance Recycled Board Using Waste Parts” discloses an invention regarding a method for manufacturing a recycled board, in which a waste carpet is first crushed to a size of 5 to 10 mm using a high-speed mill having a speed of 1,000 to 1500 rpm, is partially melted, is cut to 20 to 30 cm, and secondly crushed to a size of 5 to 10 mm, thereby manufacturing a recycled board. Korean Patent No. 10-0714990 entitled “Apparatus for Recycling Construction Wastes and Automobile Waste Carpet” Parts” discloses an invention regarding a method in which recyclable molding materials are formed by incompletely incinerating waste materials including plastics, waste asphalt concrete is melted using heat generated during incineration and separated into aggregates and asphalt, and Various contaminants generated during incineration and separation are purified and discharged into the atmosphere, thereby enabling various types of construction wastes and waste automobile floor mats to be recycled and also enabling heat generated during processing to be recycled.

However, the above-described conventional inventions require a waste carpet to undergo a complicated process including a primary process of crushing, melting, extruding and cooling and a secondary process of crushing, melting and extruding, and thus the productivity of recycled products is deteriorated. Therefore, there is a demand for an invention regarding a method and apparatus which can simplify the complicated process into a single process of crushing, thereby improving the productivity of recycled products.

### DISCLOSURE

### Technical Problem

An apparatus for recycling a waste automobile floor mat according to the present invention is an invention which has been conceived to overcome the problems of the above-described conventional inventions, and an object of the present invention is to provide a solution to a problem in which a waste automobile floor mat needs to undergo a complicated process including a primary process of crushing, melting, extruding and cooling and a secondary process of crushing, melting and extruding in order to recycle the waste automobile floor mat, and thus the productivity of recycled products is deteriorated.

### Technical Solution

In order to accomplish the above object, the present invention proposes an apparatus for recycling a waste automobile floor mat, the apparatus including: a plurality of conveyer belts which is sequentially disposed and transfers compressed, cut, crushed scraps; a first cutter which cuts each of the compressed, transferred scraps at predetermined intervals; a crusher which crushes the cut, transferred scraps; a pair of first hoppers into and from which the crushed, transferred scraps and polypropylene are introduced and discharged, respectively; a pair of first screw conveyers which transfer the scraps and the polypropylene discharged downward from the pair of first hoppers; a second hopper into and from which the scraps and the polypropylenes transferred by the pair of screw conveyers are introduced and discharged; a second screw conveyer which transfers the scraps and the polypropylene discharged downward from the second hopper; a melter which melts the scraps and the polypropylene transferred by the second screw conveyer; a third screw conveyer which forms an extrudate by extruding the mixed, molten scraps and polypropylene; and a second cutter which cuts the extrudate at predetermined intervals.

### Advantageous Effects

The apparatus for recycling a waste automobile floor mat according to the present invention simplifies a complicated process of processing a waste automobile floor mat, including a primary process of crushing, melting, extruding and cooling and a secondary process of crushing, melting and extruding, into a single process of crushing, mixing, melting and extruding, so that an effect arises in that the productivity of recycled products is improved.

### DESCRIPTION OF DRAWINGS

FIG. 1 is a diagram showing the sequence in which the components of an apparatus for recycling a waste automobile floor mat according to the present invention are arranged;

FIG. 2 is a side view showing devices for cutting and crushing scraps in the apparatus for recycling a waste automobile floor mat according to the present invention; and

FIG. 3 is a side view showing devices for melting, extruding and molding crushed scraps in the apparatus for recycling a waste automobile floor mat according to the present invention.

### BEST MODE

An apparatus for recycling a waste automobile floor mat according to the present invention includes: a plurality of conveyer belts 100 which is sequentially disposed and transfers compressed, cut, crushed scraps; a first cutter 110 which cuts each of the compressed, transferred scraps at predetermined intervals; a crusher 120 which crushes the cut, transferred scraps; a pair of first hoppers 130 into and from which the crushed, transferred scraps and polypropylene are introduced and discharged, respectively; a pair of first screw conveyers 140 which transfer the scraps and the polypropylene discharged downward from the pair of first hoppers 130; a second hopper 150 into and from which the scraps and the polypropylenes transferred by the pair of screw conveyers are introduced and discharged; a second screw conveyer 160 which transfers the scraps and the polypropylene discharged downward from the second hopper 150; a melter 170 which melts the scraps and the polypropylene transferred by the second screw conveyer 160; a third screw conveyer 180 which forms an extrudate by extruding the mixed, molten scraps and polypropylene; and a second cutter 190 which cuts the extrudate at predetermined intervals.

### MODE FOR INVENTION

The present invention relates to an apparatus for recycling a waste automobile floor mat by means of a single process,

and also relates to an apparatus for recycling a waste automobile floor mat, the apparatus including: a plurality of conveyer belts 100 which is sequentially disposed and transfers compressed, cut, crushed scraps; a first cutter 110 which cuts each of the compressed, transferred scraps at predetermined intervals; a crusher 120 which crushes the cut, transferred scraps; a pair of first hoppers 130 into and from which the crushed, transferred scraps and polypropylene are introduced and discharged, respectively; a pair of first screw conveyers 140 which transfer the scraps and the polypropylene discharged downward from the pair of first hoppers 130; a second hopper 150 into and from which the scraps and the polypropylenes transferred by the pair of screw conveyers are introduced and discharged; a second screw conveyer 160 which transfers the scraps and the polypropylene discharged downward from the second hopper 150; a melter 170 which melts the scraps and the polypropylene transferred by the second screw conveyer 160; a third screw conveyer 180 which forms an extrudate by extruding the mixed, molten scraps and polypropylene; and a second cutter 190 which cuts the extrudate at predetermined intervals.

Embodiments of the present invention will be described in detail below with reference to the accompanying drawings.

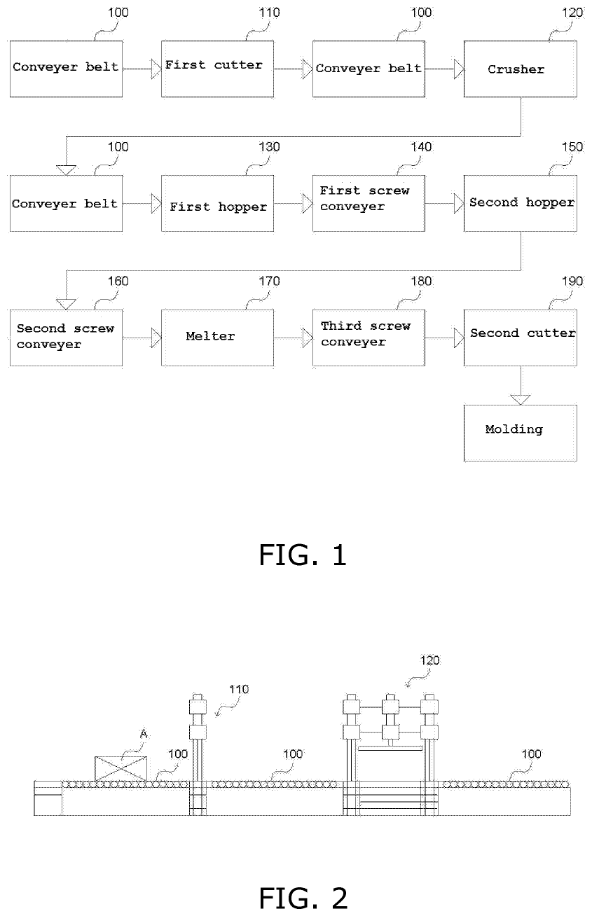

First, as shown in FIGS. 1 and 2, an apparatus for recycling a waste automobile floor mat according to the present invention is characterized by including a plurality of conveyer belts 100 which is sequentially disposed and transfers compressed, cut, crushed scraps.

The plurality of conveyer belts 100 is well-known devices which are spaced apart from each other, which transfer scraps compressed under a weight of about 500 kg, which transfer the scraps cut and divided into a planar shape, and which transfer the crushed, segmented scraps. In the following, for convenience of description, the conveyer belts 100 will be classified as and named a first conveyor belt configured to transfer compressed scraps, a second conveyor belt configured to transfer cut scraps, and a third conveyor belt configured to transfer crushed scraps.

In this case, the first conveyer belt, the second conveyer belt, and the third conveyer belt do not need to be configured to have the same shape and transfer length, but may be configured to have different types and shapes.

Furthermore, as shown in FIGS. 1 and 2, the apparatus for recycling a waste automobile floor mat according to the present invention is characterized by further including a first cutter 110 which cuts a compressed and transferred scrap at predetermined intervals.

The first cutter 110 is a device which cuts a compressed scrap, conveyed by the first conveyer belt, into a plurality of segments. Although the first cutter 110 may include a well-known hydraulic cutter configured such that the blade thereof is vertically reciprocated by hydraulic pressure, it is not necessarily limited thereto, and may thus include any type of device which can cut a compressed scrap at predetermined intervals. The scraps cut by the first cutter 110 are transferred by the second conveyer belt.

In this case, although each of the intervals at which the first cutter 110 cuts a compressed scrap is preferably equal to or less than about 100 mm when the size of the scrap after cutting and crushing and before melting is taken into account, the interval is not necessarily limited thereto. It is sufficient if the scraps are thick enough to sufficient to be inclined forward or backward and lie on the belt surface of the secondary conveyor belt after the cutting.

Furthermore, as shown in FIGS. 1 and 2, the apparatus for recycling a waste automobile floor mat according to the present invention is characterized by further including a crusher 120 which crushes the cut and transferred scraps.

The crusher 120 is a device which reduces into fragments the cut scraps transferred by the second conveyer belt by crushing them. The crusher 120 is configured to include a press unit which may be configured in a regular net form or irregular net form to sculpt scraps lying on the belt surface of the second conveyor belt in a flat form at one time and which is vertically reciprocated by hydraulic pressure.

In this case, the size of each of the scraps cut by the press unit 110 is about 600 mm in lateral length and 1,500 mm in vertical length. The scraps are inclined forward or backward, preferably the forward direction in which the scraps are transferred, after cutting and lying on the belt surface of the secondary conveyor belt. Therefore, it is obvious that the size of the press unit needs to be determined by considering the range of deviation from an accurate position due to recoil upon collision with the belt surface of the secondary conveyor belt.

In other words, it is preferable that the size of the press unit be configured such that the lateral length exceeds 600 mm and the vertical length exceeds 1,500 mm.

Each of the scraps crushed by the press unit is preferably about 100 mm×100 mm in size. The scrap crushed into pieces having a size of about 100 mm×100 mm is transferred to the third conveyor belt and immediately used without undergoing a process of being crushed into smaller sizes. Therefore, the present invention has the effect of improving the speed of the process compared to the conventional process.

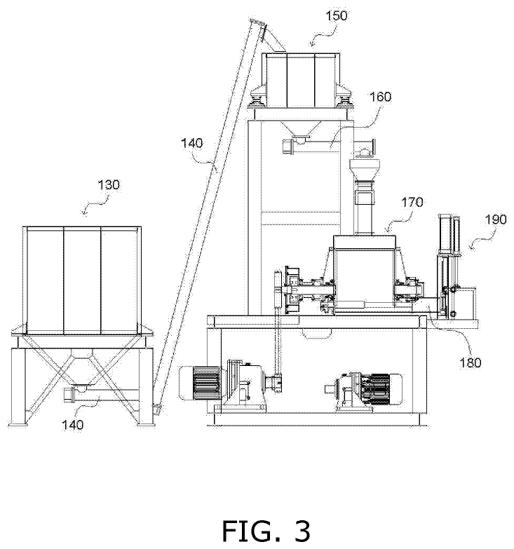

Furthermore, as shown in FIGS. 1 and 3, the apparatus for recycling a waste automobile floor mat according to the present invention is characterized by further including a pair of first hoppers 130 into and from which crushed and transferred scraps and polypropylene are introduced and discharged.

Generally, a hopper refers to a funnel-type device in which an inlet formed at the upper end thereof is larger than an outlet formed at the lower end thereof. The pair of first hoppers 130 in the present invention are formed in a shape which is the same as or similar to that of common hoppers. The pair of first hoppers 130 include: one first hopper 130 into and from which scraps transferred by the third conveyor belt are introduced and discharged or scraps transferred by the third conveyor belt, put into a separate storage container, and then transferred by an operator are introduced and discharged; and the other first hopper 130 into and from which polypropylene is introduced and discharged.

As described above, outlets are formed at the respective lower ends of the pair of first hoppers 130, and thus scraps and polypropylene introduced into the respective first hoppers 130 are immediately discharged through the lower ends. However, the apparatus for recycling a waste automobile floor mat according to the present invention is characterized by further including a pair of first screw conveyers 140 which transfer scraps and polypropylene discharged downward from the pair of first hoppers 130, respectively, so that the scraps and the polypropylene are not discharged at the same time but the polypropylene is discharged after the discharge and transfer of the scraps.

The pair of first screw conveyers 140 are devices which sequentially transfer scraps and polypropylene so that the scraps are first melted by a melter 170 to be described below and then the polypropylene is mixed with the molten scraps and then melted. The pair of first screw conveyers 140 include: one first screw conveyer 140 whose one side end is located below one of the pair of first hoppers 130 into and from which scraps are introduced and discharged and which is operated first; and the other first screw conveyer 140 whose one side end is located below the other of the pair of first hoppers 130 into and from which polypropylene is introduced and discharged and which is operated subsequently.

More specifically, each of the pair of first screw conveyers 140 is configured to include: a tubular housing inside which a path is formed; and a screw which is disposed along the internal path of the housing in order to easily transfer scraps or polypropylene. Scraps and polypropylene may be sequentially transferred by adjusting the rotational sequence of the screws, and the quantity of scraps or polypropylene to be transferred may be controlled by adjusting not only the rotational sequence of the screws but also the rotation times or numbers of rotations of the screws, thereby enabling predetermined quantities of scraps and polypropylene to be transferred.

Meanwhile, although the pair of first screw conveyors 140 are configured to include screws, a configuration of transferring scraps and polypropylene using a vacuum suction method may be applicable in place of the transfer method using the rotation of screws.

FIG. 3 is a side view showing some devices of the apparatus for recycling a waste automobile floor mat according to the present invention. Accordingly, it is noted that although one of each of the pair of first hoppers 130 and pair of first screw conveyers 140 which are each disposed in parallel is shown in the drawing, the pair of first hoppers 130 and the pair of first screw conveyers 140 each include two hoppers or conveyers in reality.

Furthermore, as shown in FIGS. 1 and 3, the apparatus for recycling a waste automobile floor mat according to the present invention is characterized by further including a second hopper 150 into and from which the scraps and polypropylene transferred by the pair of screw conveyers are introduced and discharged.

The second hopper 150 is a mechanism above which the other side ends of the pair of first screw conveyer 140 are located and into and from which the transferred scraps and polypropylene are sequentially introduced and discharged. The second hopper 150 may be configured in a funnel shape in which an inlet formed at the upper end thereof is larger than an outlet formed at the lower end thereof, like the pair of first hoppers 130.

Polypropylene is introduced into and discharged from the second hopper 150 after the introduction and discharge of scraps by the above-described configuration, and thus an effect arises in that the polypropylene may be mixed and melted in the melter 170 after the melting of the scraps. The second screw conveyer 160 which has the same structure as the first screw conveyer 140 but has a different length, a different size, and a different direction is provided below the second hopper 150, and thus transfers the scraps and the polypropylene, discharged downward from the second hopper 150, to the melter 170.

In this case, predetermined quantities of scraps and polypropylene are sequentially introduced into the second hopper 150 by the first screw conveyer 140, and thus the rotation time or number of rotations of the screw of the second screw conveyer 160 is preferably adjusted such that the total quantities of scraps and polypropylene are introduced into the second hopper 150.

Furthermore, as shown in FIG. 1 and FIG. 3, the apparatus for recycling a waste automobile floor mat according to the present invention is characterized by further including the melter 170 which melts the scraps and the polypropylene transferred by the second screw conveyer 160.

The melter 170 is a device which primarily melts the scraps transferred from the second hopper 150, mixes the molten scraps with the polypropylene transferred from the second hopper 150, and secondarily melts a mixture. The melter 170 is provided with a heater therein, and allows the introduced scraps and polypropylene to be melted by increasing internal temperature to 260 to 265° C.

More specifically, scraps are introduced into the melter 170, a process of performing melting to a temperature ranging from 260 to 265° C. is performed, and the molten scraps enter a paste state having high viscosity.

In this case, the melting process needs to be performed at a temperature ranging from 260 to 265° C. When the temperature is lower than 260° C., nylon and polyethylene terephthalate fiber contained in the scraps may not be melted. In contrast, when the temperature is higher than 265° C., carbonization may occur. Accordingly, the internal temperature of the melter 170 preferably needs to be maintained within the range of 260 to 265° C. Within this temperature range, nylon and polyethylene terephthalate fiber are oxidized and latex, polyethylene and ethylene vinyl acetate polymer components are maintained, resulting in an effect of obtaining a desirable melt.

Thereafter, polypropylene transferred from the second hopper 150 is introduced into the melter 170, and is mixed with melting and molten scraps. In this case, the internal temperature of the melter 170 is maintained within the range of 260 to 265° C. The melting time of the scraps is most preferably maintained for about 20 minutes. The time for which the polypropylene is mixed with the molten scraps and then the mixture is melted is about 10 minutes.

The polypropylene is a component which is added in order to improve the strength of the product of the apparatus for recycling a waste automobile floor mat according to the present invention. The polypropylene is mixed within the range of 75 to 85 parts by weight with respect to 100 parts by weight of scraps, and is mixed and melted after the melting of the scraps because the melting point of the polypropylene is different from that of the scraps.

Furthermore, as shown in FIGS. 1 and 3, the apparatus for recycling a waste automobile floor mat according to the present invention is characterized by further including the third screw conveyer 180 which forms an extrudate by extruding the mixed molten scraps and polypropylene.

The third screw conveyer 180 is a device which transfers and extrudes the mixed melt of the scraps and polypropylene which are mixed and melted by the melter 170. The third screw conveyor 180 has the same structure as the first screw conveyor 140 and the second screw conveyor 160, but may be configured to have a different length and a different size. The rotation time or number of rotations of the third screw conveyor 180 is preferably adjusted such that the total amount of the mixed melt is discharged.

Thereafter, the mixed melt which is transferred and extruded by the third screw conveyer 180 is cut at predetermined intervals and divided into moldings to be reused. As shown in FIGS. 1 and 3, the apparatus for recycling a waste automobile floor mat according to the present invention is characterized by further including the second cutter 190 as a device which cuts an extrudate at predetermined intervals.

In this case, although the second cutter 190 may include a well-known hydraulic cutter configured such that the blade thereof is vertically reciprocated by hydraulic pressure like the first cutter 110, it is not necessarily limited thereto, and may thus include any type of device which can cut a compressed scrap at predetermined intervals.

Furthermore, the apparatus for recycling a waste automobile floor mat according to the present invention may include a plurality of second hoppers 150, a plurality of melters 170, and a plurality of second cutters 190 in order to increase the quantity of scraps to be recycled. Accordingly, it will be apparent that the numbers of the pair of first hoppers 130 and the pair of first screw conveyers 140 are also increased.

The above-introduced embodiments are provided by way of example so that the technical spirit of the present invention can be sufficiently conveyed to those skilled in the art to which the present invention pertains. The invention is not limited to the embodiments described above, but may be embodied in other forms.

Parts not related to the description are omitted in the drawings in order to clearly describe the present invention. In the drawings, the width, length, thickness, etc. of a component may be exaggerated or reduced for the sake of convenience.

Furthermore, like reference numerals denote like elements throughout the specification.

### INDUSTRIAL APPLICABILITY

The apparatus for recycling a waste automobile floor mat according to the present invention overcomes the problem of the conventional inventions in which a waste automobile floor mat needs to undergo a complicated process including a primary process of crushing, melting, extruding and cooling and a secondary process of crushing, melting and extruding, and simplifies the complicated process, including a primary process of crushing, melting, extruding and cooling and a secondary process of crushing, melting and extruding, into a single process of crushing, mixing, melting and extruding, so that an effect arises in that the productivity of recycled products is improved. Therefore, the present invention has sufficient industrial applicability.

1. An apparatus for recycling a waste automobile floor mat, the apparatus comprising:
a plurality of conveyer belts (100) which is sequentially disposed and transfers compressed, cut, crushed scraps;
a first cutter (110) which cuts each of the compressed, transferred scraps at predetermined intervals;
a crusher (120) which crushes the cut, transferred scraps;
a pair of first hoppers (130) into and from which the crushed, transferred scraps and polypropylene are introduced and discharged, respectively;
a pair of first screw conveyers (140) which transfer the scraps and the polypropylene discharged downward from the pair of first hoppers (130);
a second hopper (150) into and from which the scraps and the polypropylenes transferred by the pair of screw conveyers are introduced and discharged;
a second screw conveyer (160) which transfers the scraps and the polypropylene discharged downward from the second hopper (150);
a melter (170) which melts the scraps and the polypropylene transferred by the second screw conveyer (160);
a third screw conveyer (180) which forms an extrudate by extruding the mixed, molten scraps and polypropylene; and
a second cutter (190) which cuts the extrudate at predetermined intervals.

2. The apparatus of claim 1, wherein the pair of first screw conveyers (140) are configured to transfer a predetermined quantity of scraps to be introduced into and discharged from any one of the pair of first hoppers (130) and to then transfer a predetermined quantity of polypropylene to be introduced into and discharged from a remaining one of the pair of first hoppers (130).

3. The apparatus of claim 1, wherein the melter (170) primarily melts the scraps transferred from the second hopper (150), mixes the molten scraps with the polypropylene transferred from the second hopper (150) to form a mixture, and secondarily melts the mixture.

4. The apparatus of claim 3, wherein an internal temperature of the melter (170) is maintained within a range of 260 to 265° C.
